(19) United States
(12) Patent Application Publication
(10) Pub. No.: US 2023/0293922 A1
(43) Pub. Date: Sep. 21, 2023

(54) FireFighter1

(71) Applicant: Bianca C. Wittenberg, El Dorado Hills, CA (US)

(72) Inventor: Bianca C. Wittenberg, El Dorado Hills, CA (US)

(21) Appl. No.: 17/699,132

(22) Filed: Mar. 20, 2022

(51) Int. Cl. A62C 33/00; A62C 99/00

(52) U.S. Cl. CPC A62C 33/00; A62C 99/009

(57) ABSTRACT

A fire defense system designed to provide quick access to pool water during a fire emergency. System is lightweight, compact, simple to use, cost effective & designed to stay readily available so a user can extract pool water to combat fire or create defensible space. In its preferred embodiment, FireFighter1 consists of a fire hose with spray nozzle on one end and male adapter on other, female mating adapter for pool pump, a water diverter, and is housed for easy release. FireFighter1 connects to 3-way diverter installed on the pool pump with mating adapter. In the event of a fire emergency, FireFighter1 hose is connected to the female adapter; 3-way diverter is positioned on; pool skimmer line is plugged; pool pump is turned on; the accordion folds expand releasing hose and user aims nozzle to spray pool water to protect assets, to fight fire, and/or to create defensible space.

### FIELD OF THE INVENTION

The purpose of this invention, FireFighter1, is to contribute to the prevention of homes and/or infrastructure loss to fires and/or wildfires. The field is specifically related to firefighting equipment. This invention relates to firefighting systems that connect to a pool or water pump, providing quick access to previously inaccessible water during fire emergencies. It is designed for easy storage; to be easily operable by the average property owner; with minimal weight, components and cost; while producing maximum effectiveness at fighting fires and/or creating defensible space. The invention uses common fire equipment parts used to fight fire, with equipment used in the installation of swimming pools and their pumping equipment, together to create FireFghter1. The unique folds in the preferred storage embodiment are key to the users not having technical issues with the hose kinking or hose getting knotted, in addition to providing the ability for the FireFighter1 hose to be stored close by and not permanently attached to pool pump equipment where it would experience wear from the ailments.

### DESCRIPTION OF RELATED ART

One prior art is described in the expired U.S. Pat. No. 5,366,021 (reference 2)

In this patent firefighting equipment was designed to connect to a pool pump with a 3-way valve and operate by the pressure of the pool pump circulating water. The device is heavy, overly restrictive for the everyday user, and not configured for rapid deployment or convenient storage. The rolled hose design takes significant time to unreel, requires extra components that stick and add weight, while not providing full concurrent access to both ends of the hose connection input and hose nozzle output end in close proximity to the water pump. This system does not provide a solution for accessing the pool water once water falls below the skimmer line. And additionally, the device is designed to be permanently installed with the pool pump where it is bulk and susceptible to damage. Our design is compact, light-weight, able to detach from the pump for safe storage and provides a system for redirecting water flow to the bottom of the pool to have full access to all the water available.

### SUMMARY OF THE INVENTION

FireFighter1 is a firefighting system that can be attached to a high-pressure side of a swimming pool pump. It is designed to provide quick access to unused pool water resources and be easily, rapidly usable by the average pool owner during a fire emergency. The fire hose of the system is quickly connected to the high-pressure side of the user's pool pump and water pressure is diverted to the base of the pool, providing the ability to rapidly extract pool water, create a hydrant quality stream of water spraying 40+ feet and create defensible space and/or fight fire.

### BRIEF DESCRIPTION OF THE IMAGES & FIGURES

Image 1 is a top view of the FireFighter1 hose extended at the ideal 50% ratio to begin folds.

Image 2 is a front view of starting the first folds in protective housing.

Image 3 is a top/side view of the accordion folds completed by one half of the FireFighter1 hose.

Image 4 is a top view of the completely folded invention of FireFighter1 in its casing, 25 foot unit.

Image 5 is a top/front view of two (2) FireFighter1 units reflecting folds allowing for rapid deployment of hose, ability for hose nozzles to be accessible from output side and concurrently firehose connection to be readily accessible at input end of hose. Right unit is rolled in a double stack and can be kept in a casing or hung with a hose rack or reel for storage.

Image 6 is a top view of the completely folded invention of FireFighter1 in its casing, 50 foot unit.

Image 7 is a top/front view of the invention of FireFighter1 in its closed housing.

Image 8 is a front view of two (2) FireFighter1 units without a casing. Top unit is a 25′(twenty-five) foot FireFighter1 hose with connection to stay permanently installed with coupling on a 3-way diverter. Bottom unit is a 50′(fifty) foot FireFighter1 unit prepared with a quick-disconnect option.

Image 9 is a front perspective view of said 3-way diverter referred to in image 13, with coupling installed, available with a FireFighter1 unit on standby at pool pumps side.

Image 10 is a front view of a 100′ (100 foot) FireFightr1 hose hanging with the prong option.

Image 11 is a front view of said 3-way diverter referred to in image 13 with coupling installed and available. FireFighter1 is connected to pool pumps with a quick-connector.

Image 12 is a top view of a “typical” pool pump with 2.4 HP Pentair Pool Pump where in normal circumstances water flows directly from the high-pressure outlet of the pump to the input port on the filter. The pipe has a right-angle bend in it.

Image 13 is a front view of a “typical” pool pump with 2.4 HP Pentair Pool Pump where in normal circumstances water flows straight through the piping. Ideal for installation to minimize pressure drop.

Image 14 is a top view of the same said “typical” pool pump referred to in image 7, with 3-way diverter replacing the right-angle bend above pump output with the main water flow taking a right angle through the diverter. The remaining port coupling is customized to connect FireFighter1.

Image 15 is a front view of the same said “typical” pool pump referred to in image 13, with 3-way diverter installed so water normally goes through the two diverted ports at 18o degrees to each other, while the port at a 90-degree angle has a coupling that is customized to connect FireFighter1.

Image 16 is a top-down view into the pool skimmer pipe showing the input and output flow holes that are plugged with our “U” shaped union pictured, that plugs into those ports to redirect flow of water from skimmer to bottom of pool.

Image 17 is a front view of the fire hose outside of the housing, folded optimally every 6″.

FIG. 1 is a diagram view of a “typical” pool pump setup.

FIG. 2 is a diagram view drawing of said “typical” pool pump setup referred to in FIG. 1 with 3-way diverter installed on the high-pressure side of the pump prior to Filter ready for FireFIghter1 unit.

FIG. 3 is a diagram view drawing of a pool piping diagram before alteration where in normal circumstances water flows straight through the piping from the pump to the filter.

FIG. 4 is a diagram view drawing of a pool piping diagram after alteration of 3-way diverter.

FIG. 5 is a diagram view drawing of a pool piping diagram after alteration with the installation of 3-way diverter, with FireFighter1 invention hose connected.

FIG. 6 is a diagram view drawing before alteration where in normal circumstances water flows from the pump to the filter via a right angle bend in the piping.

FIG. 7 is a diagram view drawing of a pool piping diagram after alteration with the 3-way diverter, replacing the right-angle bend in FIG. 6.

FIG. 8 is a diagram view drawing of a pool piping diagram after alteration with the 3-way diverter, replacing the right-angle bend in FIG. 6 with FireFighter1 hose connected to the third port on the 3-way diverter.

FIG. 9 is a front perspective drawing of the pool piping diagram from FIG. 6, after alteration, with a tee in place of a 3-way diverter.

FIG. 10 is a front perspective drawing of the pool piping diagram from FIG. 6, after alteration, with a tee in place of a 3-way diverter and FireFighter1 hose connected to the tee.

### DETAILED INVENTION DESCRIPTION

FireFighter1 is a fire defense hose system designed to give near instant access to any available pool of water in the event of a fire emergency by using the pool pump, so a user can extract that water to combat fire and/or create defensible space. The fire hose defense system was designed with the user in mind, making the system easy to use, durable, cost effective and available for property owners wanting to contribute to fighting by fire with their own valuable water resource. The fire hose system is designed to utilize an existing water pump system and available pool of water to extract and spray water at high pressure, capable of sending a stream of water above multi-level structures. The high-pressure range also provides the ability to spray water at an active, closer fire, while still maintaining a safer distance.

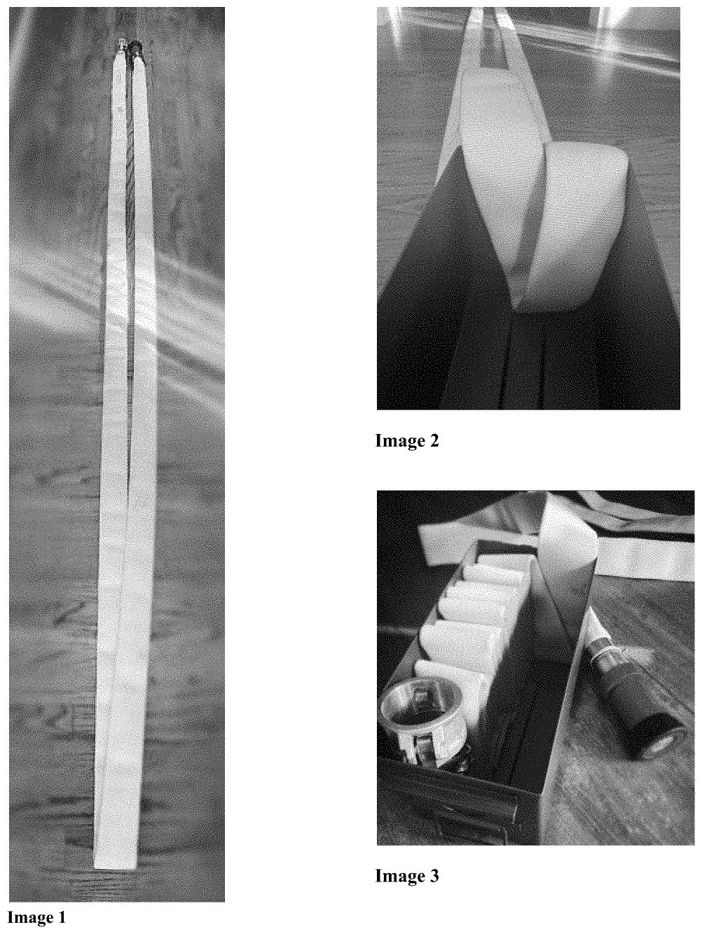

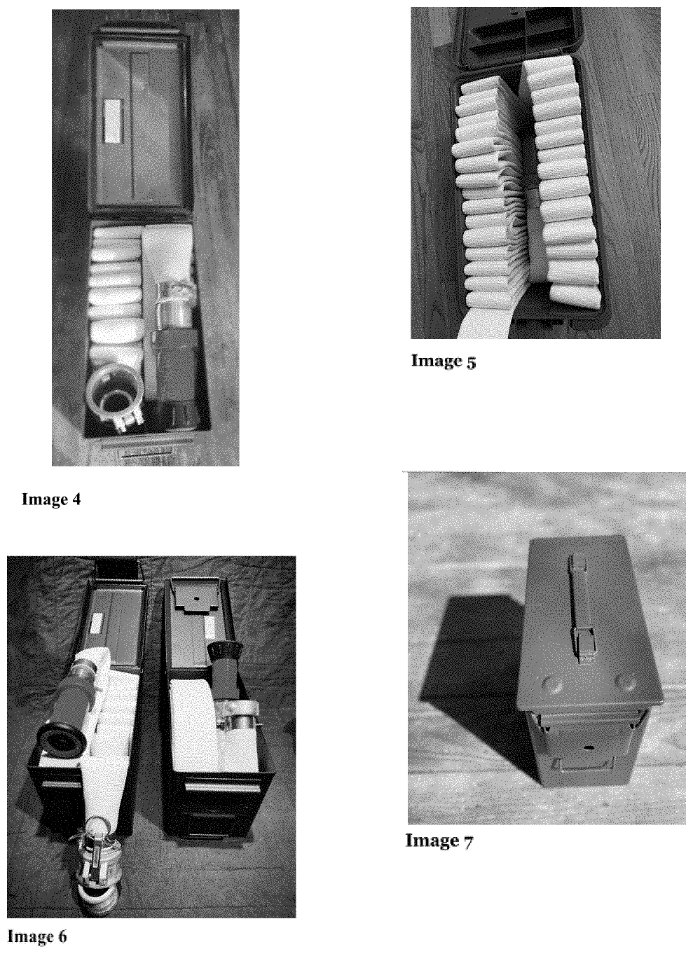

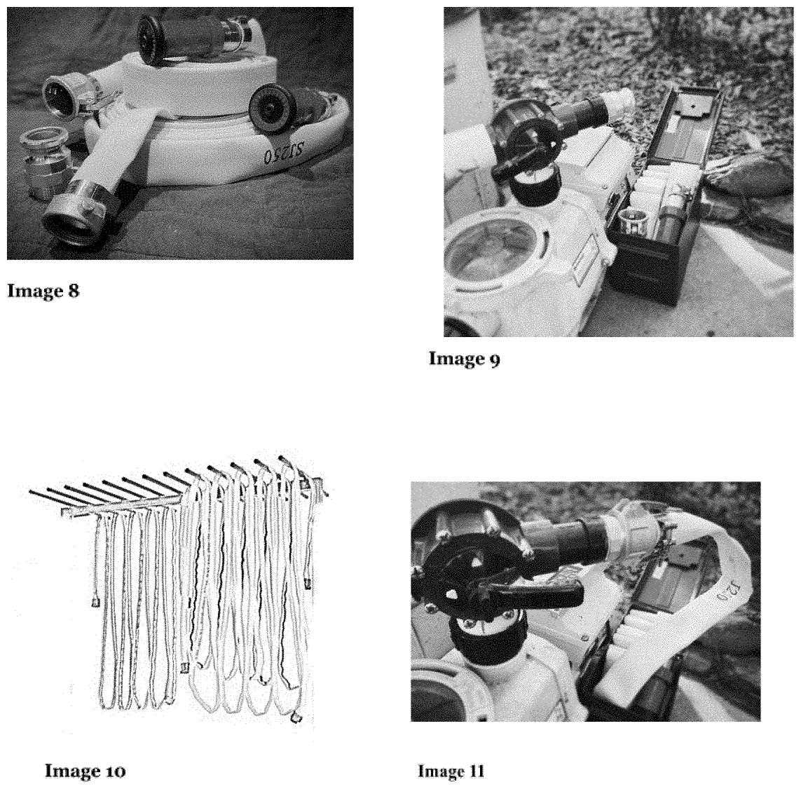

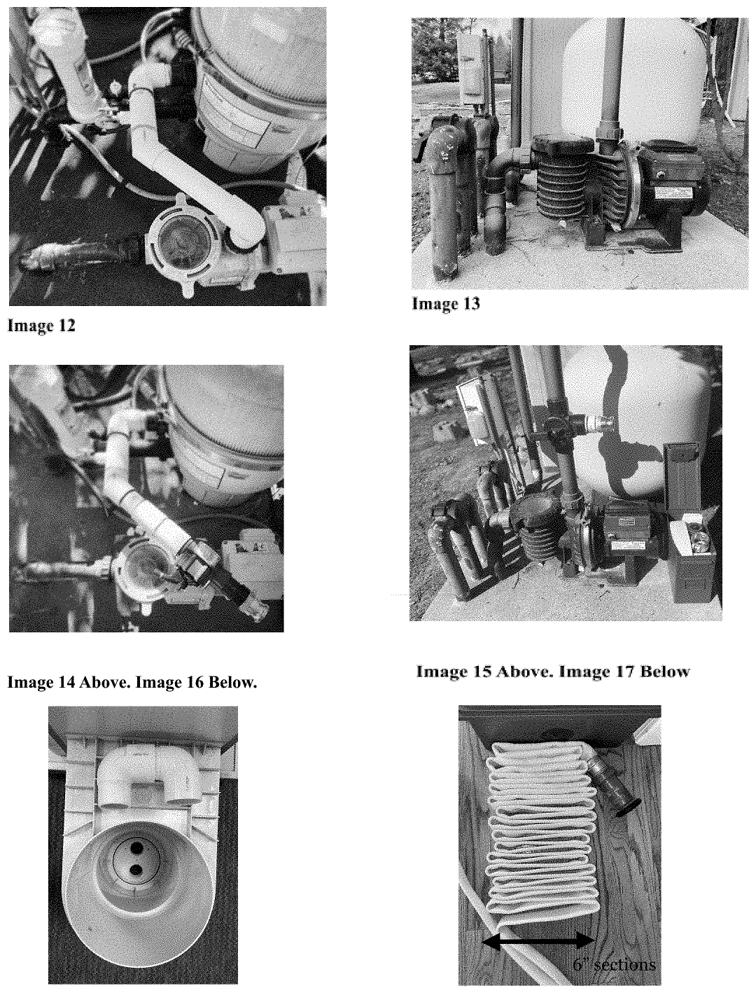

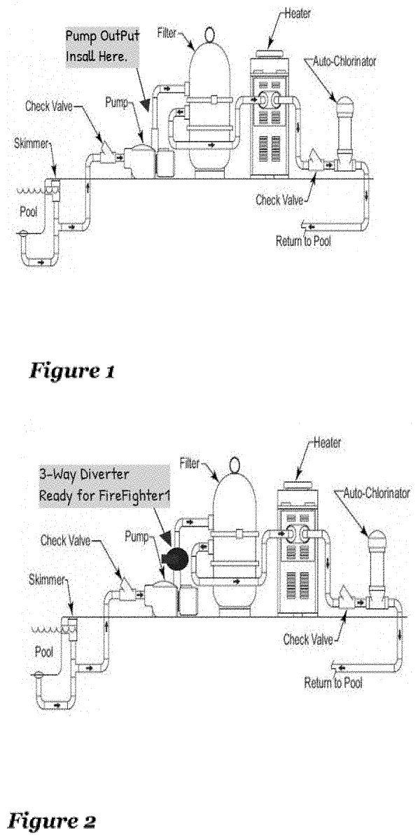

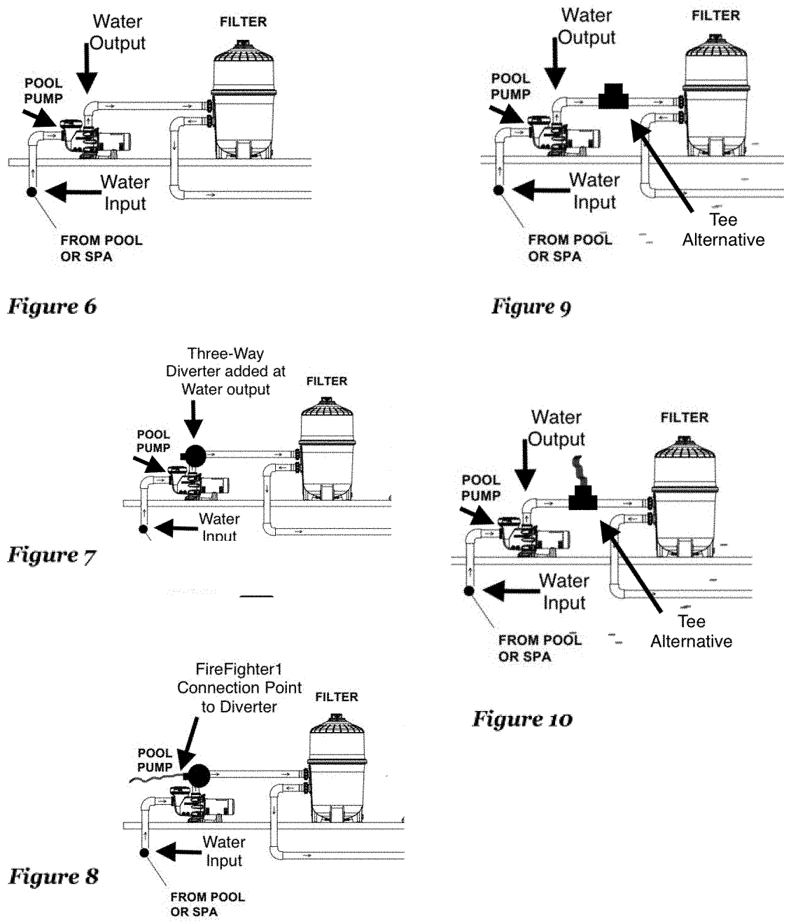

The Optimal Fire Defense Hose System consists of:
a. An existing 0.5 to 8 HP water pump as found in most home swimming pool installations. A home pool pump is typically 1.5 HP to 3 HP.
b. A water-filter. The high-pressure output of the water pump is connected to said filter with piping as depicted in image 14, image 15, FIG. 1 FIG. 4 and FIG. 6. While the water filter is normally in a pool installation, in cases where it is omitted, and water returns, for example, directly to the pool, the Fire Defense Hose System will still be fully functional.
c. A 3-way diverter. This diverter valve is inserted on the high-pressure side of the water pump such that in normal circumstances water flows through the two ports inline with each other (i.e., at 18o degrees) as depicted in FIG. 2, FIG. 5 and FIG. 15. Alternatively, the diverter valve can be installed with the main water flow normally going through two ports at right angles as depicted in Image 14 (not the best for this) and FIG. 6 and FIG. 7. The inline installation is optimal for limiting pressure drops in the piping system, unless prior to installation the diverter valve can replace an existing 90-degree bend.
d. A fire hose male connector. This is inserted into the one port of the 3-way diverter valve that is not connected to a water in or out pipe, as reflected in Images 9, Images 14, Image 15, FIG. 5 and FIG. 7.
e. A fire hose with an internal diameter between 0.5 and 3 inches, and preferably 1.5 or 2 inches, with a spray nozzle at one end and a female hose connector on the other where this female hose connector is suitable to be attached to the male hose connector on the 3-way diverter valve as reflected in Images 1 and 3. This fire hose can be continuously attached or just attached when needed as reflected in image 11 (preferred setup).
f. A storage device for the fire hose when it's not in use where the hose is folded in the device in accordion fashion at a rate of folds of one-fold per 3″ to 18″ of hose length as reflected in Images 2, 3, 4, 5, 11 and 17. Minimum housing width size, double hose diameter at 3″×6″×8″ or 144 cubic square inches, height variable based on hose length. Optimal size for a 25′ unit, 6″×8″×12″; or a 50′ unit 8″×14″×17″; 14″×12″×22″ for a 100′ unit.

The first prototypes of the FireFighter1 system were built with the hose wound on a reel, had many moving parts within the reel and for the hose to connect to the pump, in addition to not being aesthetically pleasing and expensive to construct. A few focus group experiments were conducted concluding that consumers loved the idea of the system, but felt the product was too big, too heavy, too expensive, difficult to operate and not something pool owners wanted sitting by their pool pump overall.

First corrective action was to remove the reel system, and eliminate as many components as possible. Next task in construction was to find parts that would
1. Reduce weight
2. Reduce costs
3. Reduce places for possible leaking
4. Simplify the system.

Multiple valves, fitting, components and couplings were experimented with. Multiple types of hoses were tested in rolled and folded storage configurations; experiments were done with hoses of different densities, different fabric types and different ply levels; the hose was used dry, and wet in storage tests, and repeatedly tested until the proper fire defense hose system in quality, weight, storability and functionality was found.

The manner in which the hose is stored is important to its practical use. Ideally, both ends of the hose should be available in close proximity to each other and to the pool pump. Then one person can rapidly affix the hose to the diverter valve, turn on the pump, grab the water-dispensing end of the hose and run with it to spray water. The configuration for storing and/or folding hose accordion style (Image 4) or double stacked (Image 6) meets the criteria of rapid hose deployment. A less optimal storage configuration is shown in Image 9 where the hose is folded accordion style and each fold is supported on a single rigid prong attached to a common framework. Such a configuration would mean dismounting the hose, while retaining the “accordion” by, for example, grabbing both ends of the folds and pushing in to maintain shape, from the prongs prior to connecting to the diverter valve.

Hayward & Pentair are large manufacturers producing the typical pool pumps available as reflected in Images 12, Image 13, FIG. 1, FIG. 4 and FIG. 6. Should a pool of water without a pump be accessible, a pump could be brought to the water source and Firefighter1 configured to extract that water. An alternate necessity may be backup generators available to turn on the pool pump if power sources are down. The option of purchasing a back-up power source is available with FireFighter1 or through many manufactures as a solution to this issue.

The 3-way water diverters reflected in Image 9, Image 11, Image 14, FIG. 2, FIG. 4 and FIG. 6 are designed to work with pool pumps and are used to create the connection point necessary for our fire hose system to operate. They are available from manufacturers, e.g., Hayward as reflected in Image 14; Jandy as reflected in Image 15; or Pentair and other brands. Quick-connect adapters reflected in Images 9 and Image 10 are the optimal mating choice for connecting FireFighter1 to the diverter. FireFighter1 can optionally be permanently installed with an alternate mating connector as reflected in Image 11, while still preferably being stored in a protective housing.

The 3-way diverter valve, although optimal, can be replaced by a simple “T” connection and two on/off valves as shown in FIG. 9 and FIG. 10.

Further in a less desirable and less expensive configuration, the two-way valve on the filter side of the “T” can be eliminated. Then, when the two-way value going to the hose is turned on, and the water pump is on, water has a choice to flow through the hose or the filter (FIG. 11). Unless the hose nozzle is almost closed, it is likely the filter will have sufficient resistance to flow that the main water flow will still go through the hose.

A housing for Firefighter1, as reflected in Images 4, Image 7, Image 9 and Image 11, provides the ability to leave the fire hose defense systems disconnected from this connection point and avoid possible destruction or damage due to weather or other environmental conditions. Additionally, it provides the ability for the hose to remain properly folded at the optimal 3″ to 18″ ratio for quickest use, as reflected in Images 2, Image 3, Image 4, Image 5 and Image 6. This simple design and connection configuration solved the problems of 1.) reducing the overall system weight with less components and lighter weighted materials 2.) cost effectiveness by being at a price range similar to that of other substantial household or property maintenance items 3.) complication, with minimal connection points eliminating areas at risk for leaking with a simplified system.

A coupling connects the FireFighter1 system to a 3-way diverter, which in turn is connected to the pool or water reservoir pump. For our intended use, the diverter is connected to the high-pressure output side of the pool water pump. When ready to use FireFighter1, make sure the pool float valve is in place or our custom “U” shaped connector diverting the flow of water from the skimmer to the bottom of the pool. Then, connect the hose to the diverter, or if already connected, turn the diverter valve to flow water from bottom of pool to FireFighter1, then turn the pool pump “on”. The pump output pressure provides a quick high-pressure stream of water, available almost immediately through the end nozzle of the fire hose. The unique and specific folds of the fire hose defense system provided a similar amount of time for said user to pull the hose out, to that of the opposite end filling with water. A fire hydrant quality stream of water exits the nozzle to fight fire and/or create defensible space with available pool water as the invention is intended to do.

### REFERENCES

1. Sacramento State MBA Thesis Project—FireFighter1 Last Accessed Mar. 8, 2021 http://csus-dspace.calstate.edu/handle/10211.3/213835?fbclid=IwAR11POGCxGVm3Z4yOfDrodJI4 Vjet2Zlxtor-IBpf_h9q2cW7d3v7T62ceA
2. Coleman Hose Expired Patent—Last Accessed Mar. 9, 2021 http://patft.uspto.gov/netacgi/nph-Parser?Sect1=PTO1&Sect2=HITOFF&d=PALL&p=1&u=%2Fnetahtml%2FPTO%2Fsrchnum.htm&r=1&f=G&l=50&s1=5,366,021.PN.&OS=PN/5,366,021&RS=PN/5,366,021

1. Afire defense hose system comprising a design to quickly connect to and be powered by a standard pool pump available at residential homes or infrastructure assets with pools of water available nearby; constructed in its preferred embodiment allows for quick access, quick hose release and easy use (Image 4, Image 9 & Image 11)
A. a fire hose, with a spray nozzle on one end and unique hose connector on the other as reflected in Image 8, housed simply and uniquely for clean easy storage and quick hose release when water is pumped through (Image 1, Image 4, Image 5 & Image 6)
B. a 3-way diverter system installed on the high-pressure side of the pump between the pool pump and filter (Image 9, Image 11, Image 14 and Image 15. FIG. 2, FIG. 5 and FIG. 7)
C. a unique mating connector installed on the third free port of the 3-way diverter, as reflected in Image 10 (Image 6, Image 9, Image 11, Image 14, Image 15)
D. a unique “U” shaped connector added to the pool skimmer line to divert water flow to the bottom of the pool of water (Image 16)

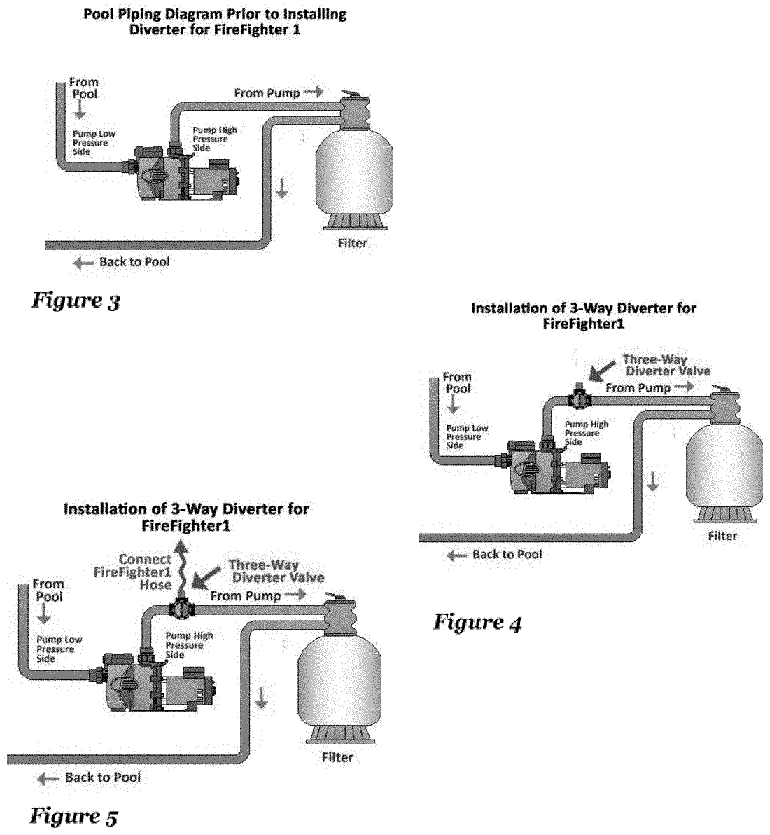

2. A system in accordance with claim 1, wherein the standard pool or water pump is 0.5 HP to 6 HP, with an output pressure between 5 psi and 4000 psi, available at residential homes or any infrastructure asset with large pools of water, optimal is 1.5 Hp-4 Hp, 30-80 PSI (Image 12, Image 13, FIG. 3 and FIG. 6)

3. A system in accordance with claim 1, wherein the 3-way diverter is installed on the high-pressure side of the pump so that in normal circumstances water flows through the two ports that are at right angles to each other, the fire hose is connected to the remaining port (Image 9, Image 11, Image 12, Image 14 and FIG. 5)

4. A system in accordance with claim, wherein the 3-way diverter valve is installed at the high-pressure side of the pump so that in normal circumstances water flows straight through the two ports that are in-line with each other, and our fire hose connector is connected to the remaining port (Image 13, Image 15 and FIG. 4)

5. An invention in accordance with claim 1, wherein FireFighter1 hose is constructed with the female end of a custom quick-connector adaptor, the male end of the connector being attached to the third port on the diverter on pool pump, providing the user the ability to attach FireFighter1 to 3-way diverter within seconds, but leave the fire hose box stored out of the way when not being used (Image 4, Image 8, Image 9, Image 11, Image 14 and Image 15)

6. A system in accordance with claim 3, wherein the 3-way diverter valve is replaced with a simple Tee connector and one on/off value is installed on the water line upstream of the Tee and another similar on/off value on the Tee line between the Tee and the hose connector (FIG. 6, FIG. 9 and FIG. 10)

7. A system in accordance with claim 4, wherein the 3-way diverter valve is replaced with a simple Tee connector and one on/off valve is installed on the water line upstream of the Tee and another similar on/off value on the Tee line between the Tee and the hose connector (FIG. 6, FIG. 9 and FIG. 10)

8. A system in accordance with claim 3 and claim 4, wherein the fire hose male connector is inserted into the third open port of the 3-way diverter providing a secure connection point between 3-way water diverter and hose (Image 9, Image 11, Image 14 and Image 15)

9. A system in a accordance with claim 1, wherein a fire hose has an internal diameter between 0.5 and 3 inches, and preferably 1.5 or 2 inches, with a spray nozzle at one end and a female hose connector on the other where this female hose connector is suitable to be attached to the male hose connector on the 3-way diverter valve (Image 1, Image 4, Image 8, Image 9 and Image 11)

10. An invention in accordance with claim 1, wherein the FireFighter1 hose is folded accordion style in its housing at a ratio allowing time for water to flow through the intake at a similar rate to that of the user extending the hose nozzle output end; When water flows through the intake, the hose's accordion folds release simultaneously allowing user full usage instantly; Folds allow for rapid deployment of the hose as it controls the rate at which the water is filled at the diverter end, while the hose is pulled by the nozzle end to where water will be sprayed; This additionally prevents the hose tangling over itself and tying in knots, so preventing the possible full extension and/or causing water flow blockage; Hoses initial fold for optimal output usage starts at the 50% ratio, allowable 20%-80% ratio (Image 1); From its optimal first half way centerfold, the hose is accordion folded at equal rates of optimally 4″-8″, (Image 17) allowable 2″-20″ fold ratio (Image 2, Image 3 and Image 5); A 25 foot hose will optimally have ten (10), five inch (5″) folds on each side, 20 folds total (Image 4); A fifty foot (50′) hose will optimally have fifteen (15), eight inch (8″) folds on each side, 30 folds total (Image 5); A 100′ Hose will optimally have fifteen (15), eight-inch (8″) folds on each side, 60 folds total; Each configuration allows for excess hose material available for folds, at nozzle end and at adapter end for clean, accessible placement; Larger hoses can be used with the same fold ratios being incrementally larger; (Image 5, Image 9, Image 11 and Image 17)

11. The invention of claim 10, wherein specific accordion folds at equal rates of optimally 4″-8″, allowable 2″-20″ fold ratio, allow quick release of hose materials from casing (Image 3, Image 4, Image 5, Image 6 and Image 17)

12. The invention of claim 10, wherein specific folds provide the user necessary time to extend hose without crimping or knotting (Image 4, Image 5 and Image 17)

13. The invention of claim 10, wherein the hose folds in the storage device allow space above and below the folds for hose nozzles to be accessible at one end and the fire hose connection readily available at the other (Image 4 & Image 9)

14. The invention of claim 10, wherein said hose can be rolled to hang, instead of folded if the user chooses. Hose is first folded at the center or optimal 50% ratio, allowable 20%-80% ratio, (Image 1) then rolled as a double stacked hose, hung on a wall or fence near the pool pump, available for quick access, leaving both the adapter input end and nozzle output end available (Image 6 & Image 8)

15. The invention of claim 10, wherein said fire hose is contained in a protective, water resistant casing providing protection from the environment, while providing a strong housing to hold the fire hose, folded at optimal usage, with instant access to both the input connector end and output fire nozzle end (Image 4, Image 5, Image 6 and Image 7)

16. A system in accordance with claim 1, wherein said fire hose can be hung on a wall or nearby fence with a simple prong system, with one prong for each loop of fire hose between 1 foot and 5 feet long. Prong system with 5 prongs holding a 25-foot unit, to 30 prongs holding a 150 foot hose, or even larger could be used with similar ratios (Image 8 & Image 10)

17. An invention in accordance with claim 1, wherein a custom “U” shaped tube is inserted between the input and output ports of the pool skimmer line to divert water flow to the bottom of the pool, this tool will optimally measure 1½″ on each side to fit the standard skimmer lines, can measure 1″ to 3″ if a port is not standard size (Image 16)
